(19) United States
(12) Patent Application Publication
(10) Pub. No.: US 2004/0162029 A1
(43) Pub. Date: Aug. 19, 2004

(54) Audio player assembly comprising an MP3 player

(76) Inventor: Jeff Grady, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 10/780,329

(22) Filed: Feb. 17, 2004

Related U.S. Application Data
(63) Continuation-in-part of application No. 10/615,108, filed on Jul. 8, 2003.
Application No. 10/615,108 is a continuation-in-part of application No. 10/197,367, filed on Jul. 17, 2002, now Pat. No. 6,591,085.

(51) Int. Cl. H04B 1/00

(52) U.S. Cl. 455/42; 455/344

(57) ABSTRACT

An audio player assembly comprises an MP3 player and an audio player unit operatively coupled with such MP3 player for receiving audio signals from the MP3 player. Specifically, the audio player unit comprises at least one speaker for outputting audio signals generated by the MP3 player and an FM received operatively coupled with the speaker.

### CROSS-REFERENCE TO RELATED APPLICATIONS

This is a continuation-in-part of U.S. patent application Ser. No. 10/615,108 filed Jul. 8, 2003 in the name of Jeff Grady for “FM TRANSMITTER AND POWER SUPPLY/CHARGING ASSEMBLY FOR MP3 PLAYER,” which in turn is a continuation-in-part of U.S. patent application Ser. No. 10/197,367 filed Jul. 17, 2002 in the name of Jeff Grady for “FM TRANSMITTER AND POWER SUPPLY/CHARGING ASSEMBLY FOR MP3 PLAYER,” issuing Jul. 8, 2003 as U.S. Pat. No. 6,591,085.

### BACKGROUND OF THE INVENTION

1. Field of The Invention

This invention relates to audio player assemblies adapted for usage with MP3 players. More specifically, the invention relates to an audio player assembly that includes an MP3 player and an audio player operatively coupled with such MP3 player for receiving audio signals from the MP3 player and outputting the received audio signals via one or more speakers of the audio player.

2. Description Of The Related Art

Music players of widely varying type are ubiquitous throughout the world, and have evolved through various forms over the years, from portable single transistor radios in the 1950's to tape cassette players to compact disc players and more recently to MP3 players, which enable a user to download audio material from an internet site and store same in storage medium of a player in an MP3 (MPEG-1 audio layer 3) format for subsequent selective listening.

A number of MP3 players have been developed and are commercially available, including the Nomad jukebox commercially available from Creative Labs, SonicBlue's rio volt, jukebox recorder commercially available from Archos Technology, and numerous others. A high-capacity MP3 player of such type is the iPOD™ MP3 player commercially introduced by Apple Computer, Inc. (Cupertino, Calif.) in 2001. The Apple iPOD has a capacity for approximately 1000 songs of commercial play length.

MP3 players of the aforementioned type rely on batteries for their portability, and are typically provided with a headset for user listening.

One problem associated with the small size and light-weight characteristics of such MP3 players, as requisite to their portability and ease of use, is battery life. Another problem is the personal character of the headphone-equipped MP3 player. The MP3 player may be equipped with a speaker, but its small size and light-weight characteristics limit the size of the speaker, making it less than desirable when it is desirable to transmit music to a group of persons.

The art continues to seek improvements to address the above-discussed deficiencies of MP3 players.

### SUMMARY OF THE INVENTION

This invention in general relates to audio player assemblies incorporating an MP3 player, or audio player units adapted for use with an MP3 player.

One aspect of the present invention relates to an audio player assembly comprising:

(a) an MP3 player; and

(b) an audio player unit with at least one speaker and optionally an FM receiver operatively coupled with said speaker, wherein said audio player unit is operatively connected with the MP3 player for receiving an audio signal produced by the MP3 player and for outputting said audio signal through the at least one speaker thereof.

Preferably, the audio player is a boom box that comprises a FM receiver for receiving radio signals from adjacent radio states, while such audio player further comprises a modular docking unit having a main body portion with a docking cavity therein for docking the MP3 player. Music produced by the MP3 players is transmitted to the audio player unit and outputted by the audio player unit through its speakers.

Such modular docking unit may comprise various functional elements, including but not limited (a) means for retaining the MP3 player in position in the docking cavity; (2) coupling means for connection with an audio out port of the MP3 player, for receiving the audio signal therefrom; (3) amplifier for amplifying the received audio signal before such signal is outputted by the speaker; (4) power/charging circuitry for charging the MP3 player docked therein; (5) indicator lights for indicating the operational state of such unit (e.g., “charged” indicating that the unit is charging the battery of an MP3 player docketed therein); (6) frequency tuning control and/or frequency indicator, etc.

An FM transmitter may be integrated into the audio player unit to form a compact unit therewith, for transmitting audio signals outputted by the MP3 player to the FM receiver, which in turn sends such signals to the speakers for audio outputting.

The MP3 player used in the present invention is preferably, but not necessary an iPOD™ MP3 player.

Another aspect of the present invention relates to an audio player adapted for use with an MP3 player. Such audio player comprises:

(a) an modular docking unit having a main body portion with a docking cavity therein for docking the MP3 player;

(b) means for receiving an audio signal produced by said MP3 player;

(c) at least one speaker for outputting the received audio signal; and

(d) optionally, an FM receiver operatively coupled with said speaker.

Other aspects, features and advantages of the present invention will be more fully apparent from the ensuing disclosure and appended claims.

### BRIEF DESCRIPTION OF THE DRAWINGS

FIG. 1 is a front elevation view of an audio player assembly, according to one embodiment of the present invention.

FIG. 2 is a right-hand side view of the assembly of FIG. 1.

FIG. 3 is a left-hand side elevation view of the audio player assembly of FIG. 1.

### DETAILED DESCRIPTION OF THE INVENTION, AND PREFERRED EMBODIMENTS THEREOF

U.S. patent application Ser. No. 10/615,108 filed Jul. 8, 2003 and U.S. Pat. No. 6,591,085 issued Jul. 8, 2003 are incorporated herein by reference in their entireties for all purposes.

The present invention provides an audio player assembly incorporating an MP3 player, which dramatically increases the utility of the basic MP3 player.

Such audio player assembly comprises an MP3 player, and an audio player coupled with the MP3 player for receiving an audio signal produced by the MP3 player and outputting such audio signal through one or more speakers of such audio player.

Specifically, such audio player comprises a modular docking unit for docking the MP3 player. Such modular docking unit comprises a main body portion with a docking cavity for positioning the MP3 player and coupling means for connecting with an audio output port of the MP3 player to receive audio signals produced by such MP3 player. The received audio signals may be transmitted to an amplifier for amplification or modification otherwise, and amplified signal is then broadcasted by one or more speakers of the audio player.

Such modular docking unit may further comprise a power supply/charging circuitry, for connecting the MP3 player to the powering supply of the audio player, and/or for recharging the battery of the MP3 player and allowing its use to be lengthened while on battery power. For example, such power supply/charging circuitry may comprise a fire-wire port for power connection purposes and an AC charger for recharging purposes.

Preferably, such audio player is a modified boom box, which comprises an FM receiver coupled with the speakers for receiving radio signals from near-by radio stations. In place of a cassette player or a CD player as in the conventional boom box, the present invention provides a modular docking unit for docking an MP3 player, so the music generated by such MP3 player can be broadcasted by the speakers of the boom box.

Such audio player may further comprise a built-in FM transmitter, which transmits the MP3 player-originated music to the FM receiver for outputting through the speakers of the audio player. The FM transmitter in the assembly of the invention transmits music played through the MP3 player to a range of FM frequencies, enabling FM reception of audio music signals by the FM receiver, and such music can then be played through the speakers of the audio player. The FM transmitter may for example be provided having a tuning frequency in the FM band of 88-95 megaherz (MHz) and a transmission range of 4-6 feet or more. The FM transmitter may simply transmit at a frequency fixed in the aforementioned 88-95 MHz band, or the transmitter may be tunable to select a specific frequency within such spectrum.

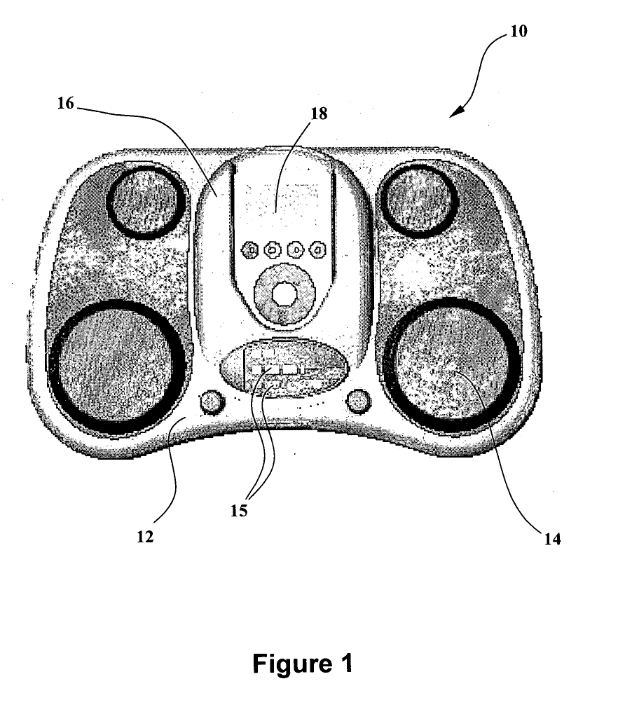

Referring now to the drawings, FIG. 1 shows a front view of an audio player assembly 10 having an audio player unit 12 with four speakers 14. Such audio player unit 12 comprises a modular docking unit 16 having a main body portion with a docking cavity therein for docking an MP3 player 18.

The modular docking unit 16 can be provided with a male connector element (not shown) matably engagable with the headphone port of the MP3 player, as well as a coupling element (not shown) matably engagable with the fire-wire port of the MP3 player, for receiving audio signals from such MP3 player. The modular docking unit 16 in the interior of its housing also includes circuitry and components for charging the battery of the MP3 player, through the fire-wire power port or other electrical input port (e.g., USB or other port) to charge the MP3 player's battery, as well as providing power to the MP3 player when docked in the modular docking unit. For more details, see U.S. patent application Ser. No. 10/615,108 filed Jul. 8, 2003 and U.S. Pat. No. 6,591,085 issued Jul. 8, 2003, the contents of which are incorporated herein by reference in their entireties for all purposes.

An amplifier (not shown) is provided in the housing of the modular docking unit 16 for amplifying the audio signal received from the MP3 player 18, while the amplified signal is subsequently transmitted to the speakers 14 of the audio player 12 for broadcasting.

As shown in FIG. 1, the lower portion of the modular docking unit has indicator lights 15, which are configured for indicating when the MP3 player is charging or fully charged, and/or when the MP3 player is “ON.”

The modular docking unit 16 may also be provided with an ON/OFF switch, or selectively actuating the MP3 player 18, charging function of the modular docking unit, etc.

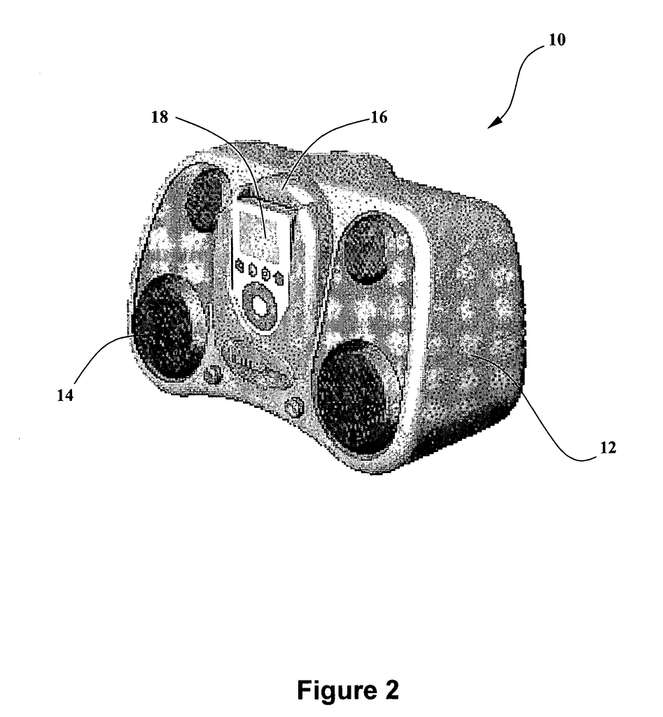

FIG. 2 is a right-hand side view of the audio player assembly 10, showing the back wall surface of the audio player 12, and a front surface thereof having the modular docking unit 16. The MP3 player 18 is positioned in a docking cavity of the modular docking unit 16.

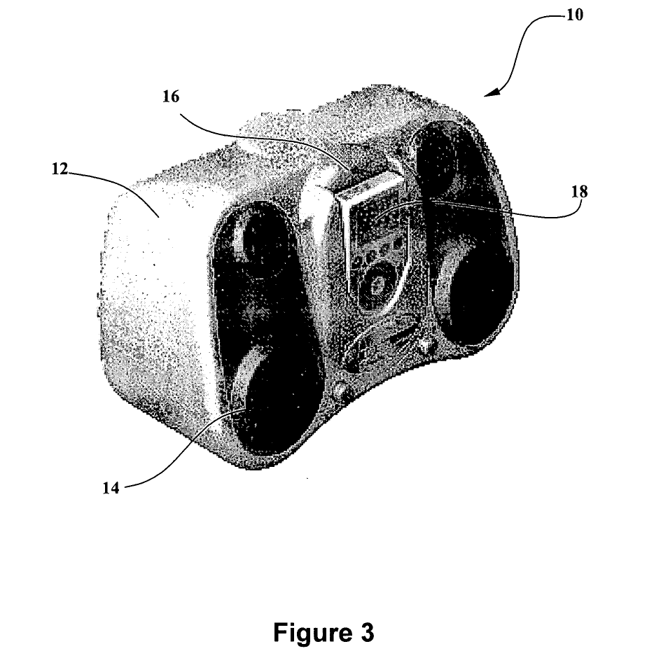

FIG. 3 is a left-hand side elevation view of the audio player assembly 10.

When the MP3 player 18 is actuated to play the stored audio content, the corresponding audio signal is transmitted through the audio output port of such MP3 player to a receiver (not shown) in the modular docking unit 16, which in turn transmits the received audio signal to the speaker 14 or an amplifier (not shown). In such manner, the audio content played by the MP3 player 18 is outputted as sound output at speakers 14.

Concurrently, the MP3 player 18 can be electrically charged to renew the battery power of the unit, so that when undocked from the modular docking unit 16, the MP3 player 18 may be outfitted with earphones and deployed in a personal listening arrangement.

Although the ensuing discussion is directed to an embodiment having specific use and applicability to the iPOD MP3 player, it will be recognized that the utility of the invention is not thus limited, but rather extends to and encompasses other MP3 players. Accordingly, although the iPOD MP3 player utilizes a firewire port for power connection purposes, other types of port and electrical connection means may be employed.

Another aspect of the present invention relates to an audio player adapted for use with an MP3 player, which comprises the modular docking unit and the speakers, as described hereinabove. A built-in FM transmitter and receiver can be provided for receiving and transmitting the audio signal from the MP3 player to the speaker of such audio player for outputting thereby.

While the invention has been described herein with respect to various illustrative aspects, features and embodiments, it will be recognized that the invention is not thus limited, but that the present invention extends to and encompasses other features, modifications, and alternative embodiments, as will readily suggest themselves to those of ordinary skill in the art based on the disclosure and illustrative teachings herein. The claims that follow are therefore to be construed and interpreted as including all such features, modifications and alternative embodiments, within their spirit and scope.

What is claimed is:

1. An audio player assembly comprising:
(a) an MP3 player; and
(b) an audio player unit comprising at least one speaker and optionally an FM receiver operatively coupled with the speaker, wherein said audio player unit is operatively connected with the MP3 player for receiving an audio signal produced by the MP3 player and for outputting said audio signal through the at least one speaker thereof.

2. The audio player assembly of claim 1, wherein said audio player unit comprises an modular docking unit having a main body portion with a docking cavity therein for docking said MP3 player.

3. The audio player assembly of claim 2, wherein said modular docking unit further comprises retention means for retaining the MP3 player in position in the docking cavity.

4. The audio player assembly of claim 2, wherein the modular docking unit comprises at least one indicator light indicative of the operational state of the unit.

5. The audio player assembly of claim 4, wherein the indicator light indicates the “ON” or “OFF” state of the unit.

6. The audio player assembly of claim 4, wherein the indicator light indicates the charging status of a battery in the MP3 player docked in the docking cavity of the modular docking unit.

7. The audio player assembly of claim 1, wherein the audio player unit comprises the FM receiver for receiving radio frequency signals.

8. The audio player assembly of claim 7, wherein the audio player unit further comprises an FM transmitter for transmitting the audio signal produced by the MP3 player to the FM receiver, which in turn transmits said audio signal to the speaker for outputting thereby.

9. The audio player assembly of claim 2, wherein said modular docking unit further comprises power/charging circuitry and coupling means in the docking cavity for connecting the MP3 player with power/charging circuitry.

10. The audio player assembly of claim 9, wherein the coupling means in the docking cavity comprises a fire-wire coupling.

11. The audio player assembly of claim 2, wherein said modular docking unit comprises an coupling means that connects with an audio out port of the MP3 player for receiving the audio signal produced thereby and transmitting the received audio signal to an amplifier in the audio player unit, wherein said amplifier is coupled with the speaker for outputting the amplified audio signal through said speaker.

12. The audio player assembly of claim 2, wherein the modular docking unit comprises a frequency indicator on the main body portion.

13. The audio player assembly of claim 2, wherein the modular docking unit comprises a frequency tuning control on the main body portion.

14. The audio player assembly of claim 2, wherein the main body portion of the modular docking unit has a generally rectangular shape.

15. The audio player assembly of claim 1, wherein said MP3 player comprises an iPOD™ MP3 player.

16. The audio player assembly of claim 1, wherein said audio player unit comprises a boom box unit having an FM receiver for receiving radio frequency signals.

17. An audio player adapted for use with an MP3 player, comprising:
(a) an modular docking unit having a main body portion with a docking cavity therein for docking the MP3 player;
(b) means for receiving an audio signal produced by said MP3 player;
(c) at least one speaker for outputting the received audio signal; and
(d) optionally, an FM receiver operatively coupled with said at least one speaker.

18. The audio player of claim 17, wherein said modular docking unit further comprises retention means for retaining the MP3 player in position in the docking cavity.

19. The audio player of claim 17, wherein the modular docking unit comprises at least one indicator light indicative of the operational state of the unit.

20. The audio player of claim 19, wherein the indicator light indicates the “ON” or “OFF” state of the unit.

21. The audio player of claim 19, wherein the indicator light indicates the charging status of a battery in the MP3 player docked in the docking cavity of the modular docking unit.

22. The audio player of claim 17, wherein said modular docking unit further comprises power/charging circuitry and coupling means in the docking cavity for connecting the MP3 player with the power/charging circuitry.

23. The audio player of claim 22, wherein the coupling means in the docking cavity comprises a fire-wire coupling.

24. The audio player of claim 17, wherein said modular docking unit comprises an coupling means for connection with an audio out port of the MP3 player, for receiving the audio signal therefrom and transmitting the received audio signal to an amplifier in the audio player unit, wherein the amplifier is operatively coupled with the speaker for outputting the amplified audio signals through said speaker.

25. The audio player of claim 17, wherein the modular docking unit comprises a frequency indicator on the main body portion.

26. The audio player of claim 17, wherein the modular docking unit comprises a frequency tuning control on the main body portion.

27. The audio player of claim 17, wherein the main body portion of the modular docking unit has a generally rectangular shape.

28. The audio player of claim 17, comprising the FM receiver for receiving radio frequency signals.

29. The audio player of claim 28, further comprising and an FM transmitter for transmitting audio signal produced by the MP3 player to the FM receiver, which in turn transmits the audio signal to the speaker for outputting thereby.

30. The audio player of claim 17, adapted for use with an iPOD™ MP3 player.

31. The audio player of claim 17, comprising a boom box unit comprising the FM receiver for receiving radio frequency signals.
